(19) United States
(12) Patent Application Publication
(10) Pub. No.: US 2015/0106349 A1
(43) Pub. Date: Apr. 16, 2015

(54) Personal Agent Homepage Integration

(71) Applicant: Microsoft Corporation, Redmond, WA (US)

(72) Inventors: Sage Kitamorn, Seattle, WA (US); Paul Thackray, Seattle, WA (US); Gautam Kedia, Bellevue, WA (US); Xiaoyuan Cui, Sammamish, WA (US); Abhishek Jha, Bellevue, WA (US); Bruno Caiado, Sammamish, WA (US)

(73) Assignee: Microsoft Corporation, Redmond, WA (US)

(21) Appl. No.: 14/052,763

(22) Filed: Oct. 13, 2013

(51) Int. Cl. G06F 17/30; G06F 3/0484; G06F 3/0481

(52) U.S. Cl. CPC G06F 17/30867; G06F 3/04817; G06F 3/04842
USPC 707/706

(57) ABSTRACT

A user profile is constructed from implicit user signals, such as prior searches, as well as from explicit user signals. The user profile informs which types of information is proactively obtained for the user. The proactively obtained information is ranked so that only the highest ranked information is proactively presented to the user. The proactive presentation of information to the user can take the form of tiles, or other like graphical elements, that can comprise images with text indicative of information that is being proactively presented to the user. User action directed to a tile can result in the presentation of further information.

### BACKGROUND

As network communications among multiple computing devices have become ubiquitous, the quantity of information available via such network communications has increased exponentially. For example, the ubiquitous Internet and World Wide Web comprise information sourced by a vast array of entities throughout the world, including corporations, universities, individuals and the like. Such information can be marked, or “tagged”, in such a manner that it can be found, identified and indexed by services known as “search engines”. Even information that is not optimized for search engine indexing can still be located by services, associated with search engines, which seek out information available through network communications with other computing devices and enable a search engine to index such information for subsequent retrieval.

Due to the sheer volume of information available to computing devices through network communications with other computing devices, users increasingly turn to search engines to find the information they seek. Search engines typically enable users to search for any topic and receive, from this vast volume of information, identifications of specific content that is deemed to be responsive to, or associated with, the users' queries. To sort through the vast amounts of information that is available, and timely provide useful responses to users' queries, search engines employ a myriad of mechanisms to optimize the identification and retrieval of responsive and associated information.

Unfortunately, a user is still required to formulate a search query, type in the search query, and parse the results provided by the search engine in order to find the information the user was looking for. Such steps are required whether the user is searching for some esoteric piece of information that the user has never looked for before, or whether the user is performing a search that they have often performed in the past looking for information that they consume on a repeated and frequent basis. In the case of the latter, it would be advantageous to the user if information could be presented to the user proactively so that the user could obtain such information with a minimum of effort.

### SUMMARY

In one embodiment, a homepage for a search service, or other like portal through which a user can access and search for information, can be modified to include the proactive presentation of information to the user. The proactively presented information can comprise information that it is anticipated the user would seek or wish to consume.

In another embodiment, a user profile can be consulted to identify information that it is anticipated the user would seek or wish to consume. Such information could then be proactively obtained, such as by processes acting as a virtual personal agent of the user, and the proactively obtained information can be sorted or ranked such that only the most important information, or the information most likely to be sought by the user, can be proactively presented to the user.

In a further embodiment, a user profile can be constructed from implicit user actions, such as prior searches performed by the user and prior information consumed by the user, the user profile can also be constructed from explicit user actions, such as explicit indications, provided by the user, identifying information that the user desires to have proactively presented to them.

In a still further embodiment, a homepage for a search service, or other like portal through which a user can access and search for information, can comprise graphical tiles, or other like visual presentation of information, that can comprise images and text representing proactively obtained information, thereby enabling the user to quickly scan and determine whether to consume more of a specific set of proactively obtained information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary network of computing devices exchanging communications associated with a personal agent homepage integration;

FIG. 2 is a block diagram of an exemplary personal agent homepage integration;

FIGS. 3a and 3b are diagrams of exemplary user interfaces comprising a homepage with personal agent integration;

FIG. 4 is a block diagram of an exemplary user interface comprising mechanisms providing for explicit user profile updating;

FIG. 5 is a flow diagram of an exemplary personal agent homepage integration; and

FIG. 6 is a block diagram of an exemplary computing device.

### DETAILED DESCRIPTION

The following descriptions are directed to user interfaces and associated mechanisms through which a user can be proactively provided with information, such as part of a homepage of a search service, or other like portal through which a user accesses or finds information. A user profile can be constructed from implicit user signals, such as prior searches, or other information the user consumes, as well as from explicit user signals, such as explicit indications that a user desires to have a defined set of information proactively presented to them. The user profile can inform which types of information are proactively obtained for the user. The proactively obtained information can then be sorted, or ranked, so that only the most important information, or the information most likely to be sought by the user, can be proactively presented to the user. The proactive presentation of information to the user can take the form of tiles, or other like graphical elements, that can comprise images with text indicative of information that is being proactively presented to the user. User action directed to a tile can result in the presentation of further information.

For purposes of illustration, the techniques described herein make reference to existing and known application user interface contexts, such as user interfaces typically presented by Web browsers and user interfaces typically presented, through such web browsers, by webpages through which a user accesses search functionality. Also, for purposes of illustration, the techniques described herein make reference to existing and known protocols and languages, such as the ubiquitous HyperText Transfer Protocol (HTTP) and the equally ubiquitous HyperText Markup Language (HTML). Such references, however, are strictly exemplary and are not intended to limit the mechanisms described to the specific examples provided. Indeed, the techniques described are applicable to any application user interface through which a user searches for and consumes information including, for example, lifestyle and/or entertainment applications, such as audio and/or video presentation applications and electronic book readers, and other content consuming and presentation applications.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

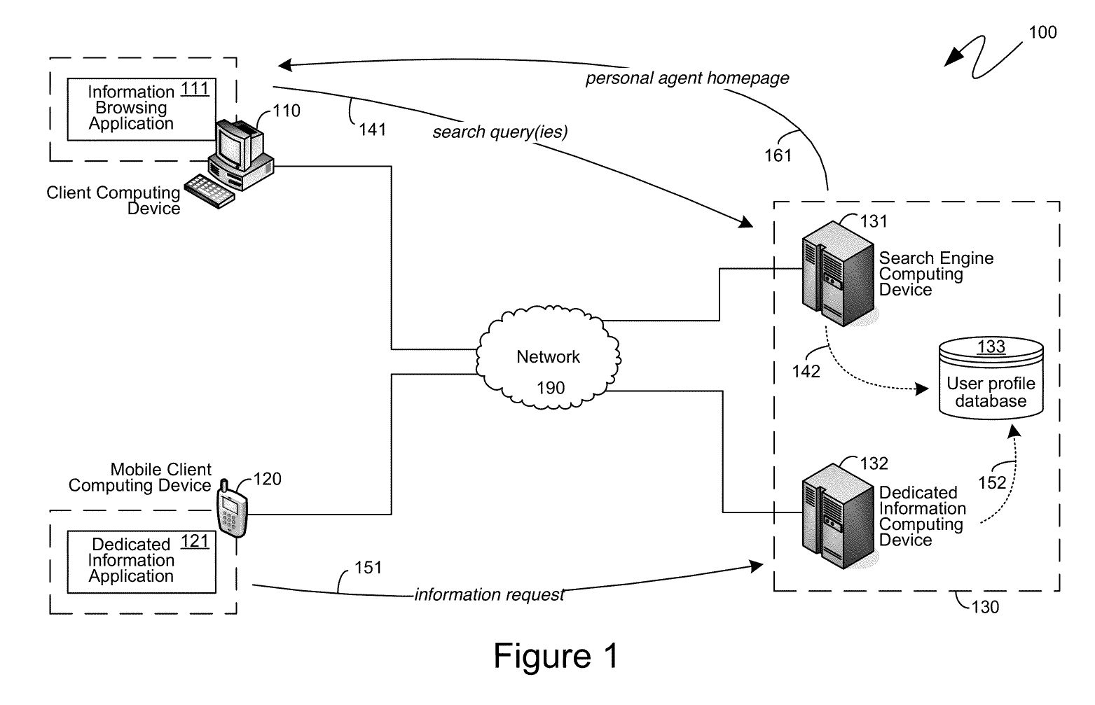

Turning to FIG. 1, an exemplary system 100 is shown, which provides context for the descriptions below. More specifically, the exemplary system 100 of FIG. 1 is not intended to be a complete illustration of all of the interactions between the various devices and components illustrated, but rather merely illustrates specific components, communications and aspects of the system that are relevant to the detailed descriptions below. The exemplary system 100 of FIG. 1 is shown as comprising a traditional desktop client computing device 110, and a mobile client computing device 120 that are both communicationally coupled to a network 190. The network 190 also has, communicationally coupled to it, a search engine computing device 131 that can provide search functionality to users of client computing devices, and a dedicated information computing device 132 that can provide dedicated information, such as weather information, stock quotes, sports scores, or other like information to dedicated information applications, such as the exemplary dedicated information application 121 being executed on the mobile client computing device 120. The presentation of such dedicated information can be through the use of the same languages and protocols utilized by the search engine computing device 131 to provide search functionality to, for example, a user of the client computing device 110, via the information browsing application 111, which is illustrated as executing on the client computing device 110. Alternatively, the presentation of information by the dedicated information computing device 132, to the dedicated information application 121, can be through different network communication protocols, including protocols that can be tailored or more efficient for the presentation of such information, such as Rich Site Summary (or “Really Simple Syndication”) (RSS) protocols. The illustration of the search engine computing device 131, and the dedicated information computing device 132, as single devices is strictly for illustrative simplicity, and the descriptions below are equally applicable to processes executing across multiple physically distinct computing devices, either in serial or in parallel.

In one embodiment, the search engine computing device 131 and the dedicated information computing device 132 can be part of a single domain 130, or can otherwise be associated, such as by being owned by the same corporate entity, such that information can be shared among and between the search engine computing device 131 and the dedicated information computing device 132. Such a domain 130 can include a user profile database 133 that can comprise user profiles defining aspects of users' interests that can be utilized, from among other purposes, to identify information that such users are likely to desire, thereby enabling such information to be proactively obtained and presented to the user without requiring the user to first make an explicit request for such information. As will be described in further detail below, the user profiles of the user profile database 133 can be generated from implicit indicators arising from prior actions by such users, including, for example, from prior searches performed by such users, prior information consumed by such users, and other like prior activities. Additionally, the user profiles of the user profile database 133 can be generated from explicit user feedback that can specifically indicate whether or not a user desires to receive proactively presented content of a given type or category.

The exemplary system 100 of FIG. 1 illustrates user utilization of the client computing device 110 and, more specifically, the information browsing application 111 executing on the client computing device 110, to perform searches 141 via the search engine provided by the search engine computing device 131. The searches 141 can provide a basis for updating a user profile in the user profile database 133, as illustrated by the arrow 142. For example, and as will be detailed further below, a user searching for the score of the Seattle Seahawks football game can be inferred to have an interest in the Seattle Seahawks football team, and such information can be encoded into such a user's profile and then subsequently utilized to proactively provide, to such a user, information about the Seattle Seahawks football team.

The exemplary system 100 of FIG. 1 also illustrates user utilization of the mobile client computing device 120 and, more specifically, the dedicated information application 121, to make information requests 151 of the dedicated information computing device 132. Such information requests 151 can also provide a basis for updating a user profile in the user profile database 133 as illustrated by the arrow 152. For example, and as will be detailed further below, the dedicated information application 121 can be a weather application and the information requests 151 can be requests for the weather at a location identified by the ZIP Code of 98052. From such information requests, it can be inferred that the user is interested in the weather at the location identified by the ZIP Code of 98052. Such information can be encoded into the user's profile and then subsequently utilized to proactively provide, to such a user, the weather at the location identified by the ZIP Code of 98052.

In one embodiment, such a proactive presentation of information can be presented as part of a personal agent functionality on a homepage of the search engine hosted by the search engine computing device 131. For example, the personal agent homepage 161, which the search engine hosted by the search engine computing device 131 can provide to the information browsing application 111, executing on the client computing device 110, can include the proactive presentation of information that the user of the client computing device 110 is thought to find desirable, based on such a user's profile from the user profile database 133. Returning to the above example, if prior search queries 141 were for scores of the Seattle Seahawks football games, the personal agent homepage 161, which can be presented when the user of the client computing device 110 initially opens such a homepage via the information browsing application 111, can proactively present, to such a user, information regarding the Seattle Seahawks football team. Similarly, as another example, if the user of the client computing device 110 is the same as the user of the mobile client computing device 120, inferences made from activities that such a user engaged in through the mobile client computing device 120 can also be utilized to tailor the information that is proactively presented via the personal agent homepage 161, even though the personal agent homepage 161 can be directed to the information browsing application 111, executing on the client computing device 110, and not to any application executing on the mobile client computing device 120. In such a manner, a user profile can be updated based on a user's implicit or explicit indications, irrespective of the vector through which such indications are provided. Thus, continuing the above example, if the user of the client computing device 110 is the same as the user of the mobile client computing device 120, and the information requests 151 from the dedicated information application 121, that is executing on the mobile client computing device 120, were directed to weather information at a specific location, than the weather at such a location can be proactively provided, as part of the personal agent homepage 161, to the user via the information browsing application 111, executing on the client computing device 110.

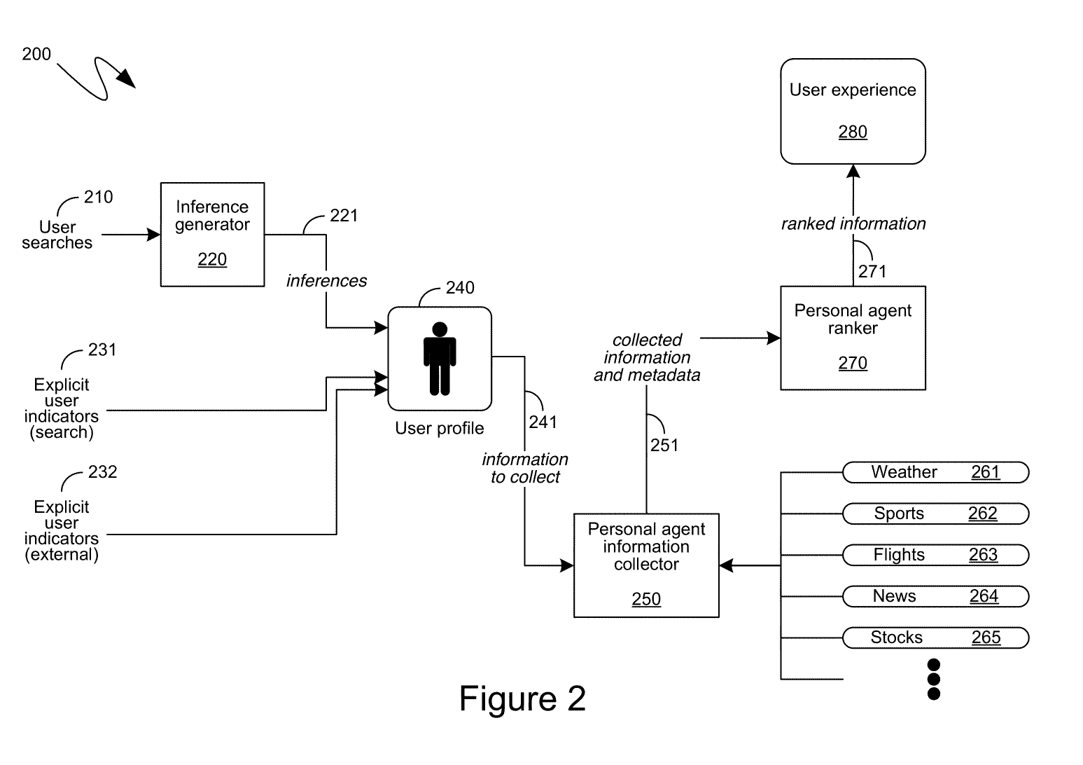

Turning to FIG. 2, the system 200 shown therein illustrates an exemplary system for proactively providing information to a user, such as through a personal agent integrated into a homepage, such as that provided by a search engine. In one embodiment, a user profile 240 can be maintained and updated based upon information received from implicit and explicit user indicators, such as the user searches 210, and explicit user indicators 231 and 232. As utilized herein, the terms “explicit user indicators” and “explicit user input” mean user input or user settings that directly specify topics, contexts or subjects that a user intends to have associated with themselves for purposes of repeatedly receiving information about such topics, contexts or subjects. By contrast, as utilized herein, the terms “implicit user indicators” and “implicit user input” mean the information received from users as part of their utilization of functionality provided by application programs executing on one or more computing devices that indirectly indicate user interest in a topic, context or subject or that evidence upcoming actions or activities that will be performed by those users at a future time. The user searches 210 that a user can have previously conducted can be provided to an inference generator 220 that can generate inferences 221 that can inform the user profile 240. The inferences 221 can comprise both data about the user that was inferred from the user searches 210 by the inference generator 220, as well as confidence levels indicating how confident inference generator 220 is of the inferences 221.

More specifically, the inferences 221 can define categories or types of information that the inference generator 220 believes that the user desires to consume, based upon the user searches 210. For example, if the user searches 210 include searches for the scores of the Seattle Seahawks football games, then the inference generator 220 can generate inferences 221 that the user is interested in information about the Seattle Seahawks football team, and such an inference can used to modify the user profile 240 so that the user profile 240 reflects the user's interest in information about the Seattle Seahawks football team. As another example, if the user searches 210 include searches for a specific flight on a specific day departing from the user's home city and traveling to another city, then the inference generator 220 can generate inferences 221 that include and inference that the user is traveling to such other city on the specific day and flight that were searched for. Accordingly, the user profile 240 can be modified to indicate that the user desires to proactively receive information about such a flight, and about the destination, such as news from such a destination, traffic reports at such a destination, and the weather at such a destination.

In one embodiment, such inferences 221 can be associated with confidence levels reflecting how confidence the inference generator 220 is of the inferences 221. For example, repeated searches about the Seattle Seahawks football team can increase the confidence of an inference that the user is interested in information about the Seattle Seahawks football team. By contrast, as another example, a single search for a particular airline flight can result in inferences having low confidence levels because it may not be clear whether it is the user themselves who is traveling, or, indeed, whether the user or anyone the user knows actually has a ticket for that flight in the first place. Such confidence levels can be subsequently utilized, such as by the personal agent ranker 270, whose operation will be described in detail below, in the ranking of proactively obtained information.

Turning to the explicit user indicators 231, in one embodiment, certain searches that a user can perform can return, from the search engine, not merely a listing of identifications of documents and other content that is deemed to be responsive to such searches, but can also return, from the search engine itself, information that is be believed to directly answer the user's question. For example, if a user were to perform a search for a specific airline flight number, the search results that would typically be returned by a search engine may link to pages or documents containing the same words as the user's query. Such links, however, may not be able to immediately answer the question that the user is likely seeking to resolve given such a search, which is the status of the flight for which the user searched. Instead, in such instances, the search engine can directly present, separate from the links to responsive documents, information that the search engine itself is aware of that appears to directly answer the user's query. In the above example, the search engine could directly provide flight information regarding the flight the user has searched for including, for example, the departure and arrival times for the flight, the departure and arrival airports for the flight, in the on-time status of the flight. In such an instance, the user can also be provided with an opportunity to explicitly indicate that the user desires to proactively receive information about the flight that they searched for. For example, when directly providing the flight information, the search engine can also provide a user interface mechanism, such as will be detailed below, that can enable the user to provide an explicit user indication that the user desires to proactively receive information regarding that flight. Such explicit user indicators 231 can be utilized to modify the user profile 240 in a similar manner as the inferences 221, except, in the case of explicit user indicators 231, the confidence can be one hundred percent.

In an analogous manner, explicit user indicators, such as the explicit user indicators 232, can come from sources external to a user's utilization of a search engine. For example, as detailed previously, a user can utilize dedicated information applications, such as whether applications, sports applications, and other like applications, including on a single computing device or across multiple computing devices. To the extent that such dedicated information applications interact with server computing devices that share information with the search engine computing devices, the user's utilization of such dedicated information applications can provide additional explicit user indicators 232 from which a user profile 240 can be further enhanced. For example, a user utilizing a weather application, such as on a smartphone computing device, can continually look up the weather for a specific location. Such repeated referencing of the weather for a specific location, through a dedicated information application, such as the weather application, can be an explicit user indicator that the user desires to proactively receive information regarding the weather at such a specific location. Such an explicit user indicator 232 can, like the explicit user indicator 231, the utilized to modify the user profile 240 and the associated modifications can be signed a high confidence level.

When a user requests a search engine homepage, or other like portals through which a user searches for and accesses information, personal agent functionality can proactively obtain information on behalf of the user and proactively present that information to the user without the user first having to explicitly search for such information. With reference to exemplary system 200 of FIG. 2, a personal agent information collector 250 can obtain, from the user profile 240, identifications of the types of information to collect 241 for the specific user that has requested the search engine homepage. Returning to the above examples, the information to collect 241, obtained from the user profile 240, by the personal agent information collector 250, could identify to the personal agent information collector that the user desires to consume information about the Seattle Seahawks football team, weather information for a given location, flight status for a given flight, and other like information, as illustrated by the above examples.

Upon obtaining the information to collect 241, from the user profile 240, the personal agent information collector 250 can obtain such information from one or more processes or information stores dedicated to such information. For example, a weather process 261 can be associated with weather data and can provide, to the personal agent information collector 250, in response to an explicit request therefrom, weather information for a specific location. Similarly, as another example, a sports process 262 can be associated with sports data, such as scores and results from sporting events and can provide, to the personal agent information collector 250, in response to an explicit request therefrom, sports scores and results for specific teams or specific events. Further exemplary processes illustrated in FIG. 2 include flight information process 263, news process 264 and stock process 265, each of which can operate in an analogous manner to that of the weather process 261 and the sports process 262. As will be recognized by those skilled in the art, the weather process 261, sports process 262, flight information process 263, news process 264 and stock process 265 are merely examples that are specifically illustrated only to aid understanding. Other processes that gather data from other sources can be equally utilized by the personal agent information collector 250 to obtain information in accordance with the information to collect 241 that the personal agent information collector 250 received from the user profile 240. Such other processes are graphically illustrated by the ellipses shown in FIG. 2.

In one embodiment, in addition to providing the raw data that was requested, such as, for example, the current price of a particular stock, the various processes from which the personal agent information collector 250 obtains information that may be desirable to the user can also provide metadata such as, for example, whether the current price of the stock is an unusually large deviation given that stock's price history. Such metadata, as will be described in further detail below, can be utilized by the personal agent ranker 270 to rank the collected information, thereby facilitating the user experience 280 in selecting which of the collected information to proactively present to the user, such as in the manner that will also be described in further detail below. As indicated by the above example, metadata can include information such as whether a current stock price is unusually low or high or is deviating in a historically significant manner. Metadata could also include information regarding the time of certain data, such as when a sporting event was completed, or when a flight is expected to take off or land. Metadata could equally include information regarding the noteworthiness of weather data such as, for example, if a weather alert has been issued or if severe weather is present. Metadata can also include information regarding the perceived importance of data to a generic or general population group. For example, use information, such as could be obtained from the news process 264, can include metadata indicating whether such news would be considered “front page news”, or whether such news has been otherwise tagged or associated with an indication of importance or significance.

Once the personal agent information collector 250 has obtained information and metadata 251, in accordance with the information to collect 241 that it obtained from the user profile 240, it can provide such collected information and metadata 251 to the personal agent ranker 270. The personal agent ranker 270 can rank at least some of the information obtained by the personal agent information collector 250 in accordance with various factors in order to identify the information that is most likely to be desired by the user and which the user would most likely wish to have proactively presented to them. In one embodiment, such a ranking can commence with a default ranking that can rank information according to its type or category as an initial ordering step. For example, a default ranking can specify that flight information is more important than sports scores but less important than stock prices. Subsequently, more specific metadata can be considered to adjust the rankings of the information collected.

One ranking methodology that can be utilized can be a time-based ranking methodology wherein information that is temporally close to a current time can have a higher rank than information that is temporally more distant from the current time. For example, flight information indicating that a flight that the user has searched for is landing within the next half hour can be assigned a higher rank, or can be weighted more highly for ranking purposes, than a flight that is landing three weeks from the current time. As another example, the score of a Sunday football game can be assigned a higher rank, or can be weighted more highly for ranking purposes, on Monday than on Friday. In employing a time-based ranking methodology, the personal agent ranker 270 can have access to time data, including data indicating a current time when the ranking is being performed, and time-based metadata associating specific ones of the information collected by the personal agent information collector 250 with specific times.

Another ranking methodology that can be utilized can be a significance-based ranking methodology wherein information that is marked as being more significant to a general population, or is marked as being more urgent, can be assigned a higher rank, or can be weighted more highly for ranking purposes, then other information. For example, weather information indicating a tornado warning can be ranked more highly than non-alert weather information. As another example, a breaking news story of national significance can be ranked more highly than more pedestrian news stories. As indicated previously, metadata obtained by the personal agent information collector 250 can include metadata indicating the significance of the information with which it is associated. Such metadata can be direct significance-indicating metadata, such as, for example, metadata associated with news information identifying such news information as being “front page worthy”, or other like classification. Alternatively, such metadata can be indirect significance-indicating metadata such as, for example, metadata associated with stock information that can identify a current stock price as deviating from a prior stock price by a given percentage, as well as providing historical highs and lows for the stock price, and a “beta” value measuring the volatility such a stock price. Such metadata can indicate significance indirectly because significance can be determined from such metadata by, for example, comparing the percentage deviation to the known volatility of a stock. As will be recognized by those skilled in the art, a given percentage deviation in stock price for stocks having low volatility can be more significant than the same percentage deviation for stocks having high volatility.

Yet another ranking methodology that can be utilized can be a confidence-based ranking methodology that can rank information based upon the confidence with which it is known that the user actually desires the proactive presentation of such information. For example, and with reference to the descriptions above, explicit user indications can have a confidence of approximately one hundred percent, since they are explicit indications directly from the user. By contrast inferences can have lower confidence levels that can be based on factors such as how often the user performed the search from which the inferences based, the type of search query that was utilized, and other like information. In ranking based on confidence, collected information that is associated with settings in the user profile 240 that have low confidence levels can be ranked lower than collected information that is associated with settings in the user profile 240 that have high confidence levels.

Still another ranking methodology that can be utilized can be a geographic-based ranking methodology that can rank information based upon geographic locations associated with such information and a current geographic location of the user. For example, if the user profile 240 were to indicate that the user lived in Seattle, but information available to the personal agent ranker 270 identified the user is currently being located in Chicago, than information associated with Chicago, such as a current weather in Chicago, could be ranked higher than information associated with Seattle. As another example, a user whose location is determined to be at an airport can have flight data be more highly ranked than other information, since such flight data would be associated with airport locations and, consequently, from a geographic perspective, would have a higher rank and other data. In one embodiment, a user's current geographic location can be obtained by the personal agent information collector 250, the personal agent ranker 270, or dedicated geographic location processes external thereto, through known methodologies such as Global Positioning System (GPS) information retrieved from the computing device the user is currently utilizing, Wi-Fi-based location determination, again retrieved from the computing device the user is currently utilizing or Internet Protocol (IP) addresses associated with such a computing device.

The personal agent ranker 270 can also implement combinations of any or all of the aforementioned ranking methodologies. For example, time-based and geographic-based ranking methodologies can be combined to recognize that, for example, a user will be taking a flight that departs into hours and the user is still geographically located at their office, and, consequently, information such as the traffic between the user's office and the airport can be ranked more highly than other information.

Once the personal agent ranker 270 has ranked the information collected by the personal agent information collector 250, it can provide to such ranked information 271 to a user experience component 280. In one embodiment, a user experience component 280 can include scripts and other like programmatic constructs that can build a homepage, or other like portal, in a manner well known to those skilled in the art. Such a user experience component 280 can generate user interface components, such as the tiles that will be described in detail below, in order to display at least a portion of the most highly ranked information 271. For example, the user interface component 280 can detect an appropriate graphical size or space within which to generate a homepage or other like user interface, and can select inappropriate quantity of the linked information 271 to generate one or more sets of tiles, such as in the manner that will be described in detail below, in order to proactively present at least the most highly ranked information 271 to the user.

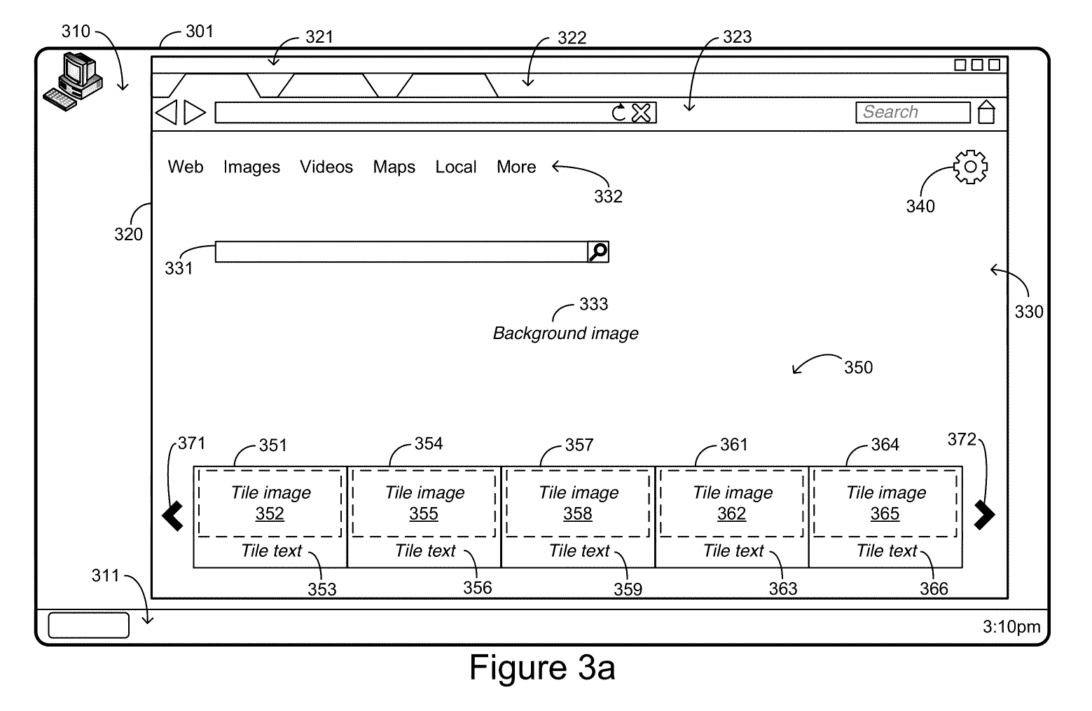

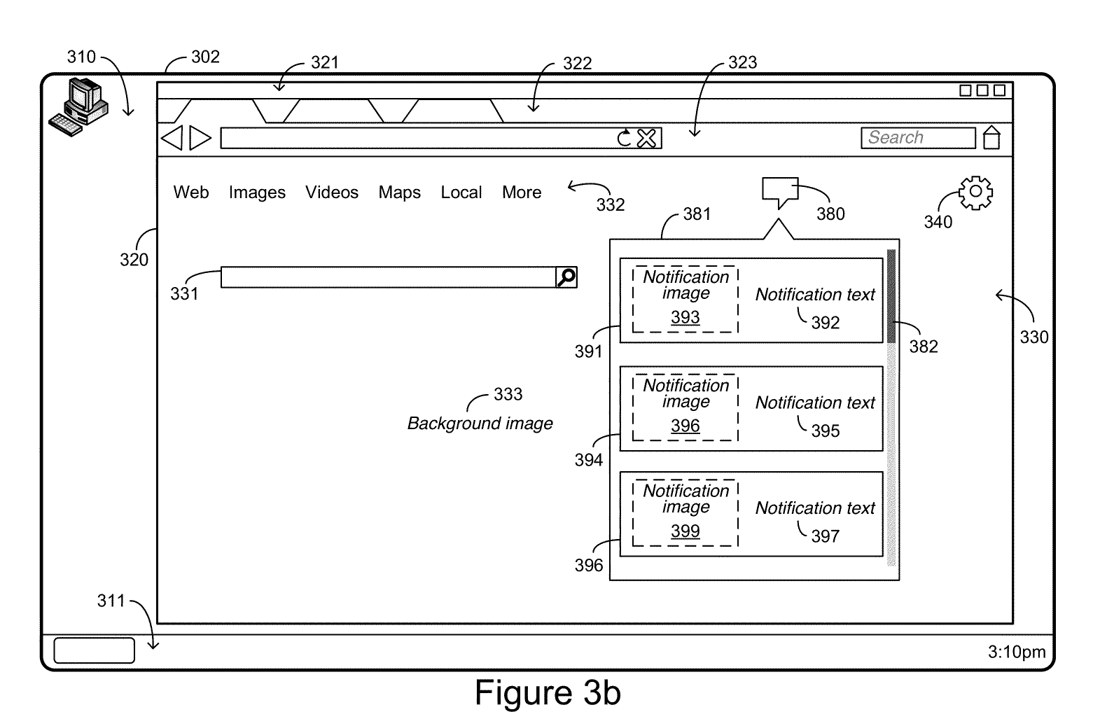

Turning to FIG. 3a, an exemplary user interface 301 is illustrated comprising a proactive presentation of information to a user via a personal agent integrated into a homepage, such as would be provided by a search engine. Although illustrated within the context of a sort of user interface that would typically be presented by a personal computing device, the descriptions provided below are equally applicable to the sort of user interfaces provided by mobile computing devices, tablet computing devices, smart phone computing devices and other like computing devices.

The exemplary user interface 301 of FIG. 3a is shown as comprising a desktop 310 within which an application window 320 is presented. In conjunction with the desktop 310, the exemplary user interface 301 of FIG. 3a can also comprise a taskbar 311. The application window 320 can be presented by an information browsing application, such as those described in detail above, which can receive and display a homepage, such as would be provided by a search engine, having personal agent integration. The application window 320 can comprise a window control area 321 with which the appearance of the window 320 within the user interface 301 can be controlled. Additionally, in one embodiment, the information browsing application can be capable of presenting multiple different sets of content within tabs, and such tabs can be accessed through a tab selection area 322.

User selection of content to be obtained and presented by the information browsing application can, in one embodiment, be controlled through a toolbar area 323, which can comprise mechanisms by which users can directly specify content, such as through content resource locators or other like content identifiers, mechanisms by which users can browse through content that was previously viewed, and other like content control mechanisms. The content itself can be displayed in a content presentation area 330 which, in the exemplary user interface 301, illustrated in FIG. 3a, can comprise content received from a search engine having personal agent functionality integrated into the homepage of such a search engine. The entry mechanism, by which users can provide search queries to the search engine, is shown in exemplary user interface 301 as the search entry area 331 that can be displayed in the content presentation area 330. The content presentation area can also include content type selectors 332 by which a user can specify which type of content they are searching for, as well as other, optional, visual embellishments, such as, for example, a background image 333.

In one embodiment, without the user having to explicitly enter a search query into the search entry area 331, the homepage of the search engine, or other like portal to the search engine, such as that illustrated in the display area 330, can proactively present information to the user that the user is expected to find desirable. One mechanism for proactively presenting such information to the user is illustrated in the exemplary user interface 301 of FIG. 3a via the tiles 350. As utilized herein, the term “graphical tile” means a bounded area, visually presented in a visual user interface, which comprises text, images or combinations thereof that are either indicative of information the user would be presented if they interacted with the graphical tile, or provide at least a portion of that information directly. In one embodiment, each of the tiles 350 can comprise a tile image, or some form of graphical content, and can also comprise, either in addition or alternatively, textual content. More specifically, and as illustrated in FIG. 3a, the tile 351 can comprise a tile image 352 and tile text 353, and, analogously, the tiles 354, 357, 361 and 364 can comprise tile images 355, 358, 362 and 365, respectively, and tile text 356, 359, 363 and 366, respectively. Although illustrated separately, tile text, such as the exemplary tile text 353 can be presented superimposed over a corresponding tile image, such as the tile image 352.

Although the tiles 350 are illustrated, in the exemplary user interface 301 of FIG. 3a, as arranged in a horizontally oriented row, other orientations and arrangements of tiles, such as the tiles 350, are equally contemplated. For example, the tiles 350 could be arranged in a vertical column, in two-dimension in tabular form, or other like orientations. Additionally, in one embodiment, the arrangement of the tiles can be dictated by the visual size and orientation of the display area 330. For example, if the display area 330 is oriented in a in landscape format, such as that shown in FIG. 3a, in the tiles 350 can be arranged horizontally, as shown, while if the display area 330 as oriented in a portrait format, where the width of the display area 330 is less than its height, then, for example, the tiles 350 could be arranged in a vertical column, such as along either the left or the right of the portrait-oriented display area 330.

The graphical and textual content presented in the tiles 350 can visually proactively present, to a user, content, or at least the indicia of content, that the user is thought to find desirable, without the user having to explicitly enter a search query into the search entry area 331. For example, a tile, such as exemplary tile 351, can include a tile image 352, such as a picture from a football game, as well as tile text 353, which can be superimposed over such an image and can convey information such as “Seahawks win 24-17”. Such an exemplary tile 351 can both proactively convey information to the user, namely the score of the Seattle Seahawks football game, as well as provide an entry through which the user can obtain further information. For example, in one embodiment, user action directed to such an exemplary tile 351 can result in the presentation of search results or other like content directed to the Seattle Seahawks football team, or the specific game whose score was indicated in the exemplary tile 351. As another example, a tile, such as the exemplary tile 354, can comprise a tile image 355 of the sun in a blue sky, as well as tile text 356 conveying information such as “Sunny 71°”. Again, such an exemplary tile 354 can both proactively convey information to the user, namely the weather at a location deemed to be of interest to the user, as well as provide an entry through which the user can obtain further information. For example, in one embodiment, user action directed to such an exemplary tile 354 can result in the presentation of further weather information, such as a ten day forecast, detailed current weather, and other like weather information associated with the location deemed to be of interest to the user. Others of the exemplary tiles 357, 361 and 364 can, likewise, comprise portions of news information, financial information, such as stock quotes, flight status, traffic information, and other like information that can have been proactively obtained based upon information that was deemed to be of interest to the user, as indicated by a user profile.

In one embodiment, the tiles 350 can be but one set of exemplary tiles, and other exemplary tiles, or sets of exemplary tiles, can be accessed via user interface mechanisms, such as the exemplary scroll indicators 371 and 372. In such an embodiment, a set of tiles 350 that is initially presented to a user can comprise information that is determined to be more relevant than information presented via tiles that can only be made visible through user action directed to the scroll indicators 371 or 372. Similarly, in one embodiment, the location of a specific tile, among the set of tiles 350, can also be based upon a determined relevance, or ranking, of the information presented via such a tile. For example, the exemplary tile 351 can comprise information that has been ranked more highly than the exemplary tile 364, such as by following a convention that people read from left to right and the exemplary tile 351 is the leftmost tile. As another example, the exemplary tile 357 can comprise information that has been ranked more highly than the exemplary tiles 354 and 361, such as by following a convention that people tend to glance more often at the middle of a set of figures and then proceed outward towards the edges. As still another example, specific information can be continuously presented in a specific location. For example, implicit user data, such as user interactivity directed to the tiles 350, can reveal that the user interacts with tiles displaying Seattle Seahawks football information more often when such information is presented as part of the exemplary tile 364 versus, for example, the exemplary tile 354. In such an example, such implicit user data can be utilized to determine that the user prefers Seattle Seahawks football information to be presented as part of the exemplary tile 364 and, consequently, such information can be presented as part of the exemplary tile 364 even if it's ranking would otherwise have resulted in its presentation as part of a more highly ranked location such as, for example, the leftmost location occupied by the exemplary tile 351.

In one embodiment, the visual size of one or more of the tiles 350 can be altered to convey significance or ranking. For example, if the information presented in the tile 351 was considered more significant, the visual size of the tile 351 could be greater and the size of other titles, such as the exemplary tiles 354, 357, 361 and 364. Such visual size alterations can be combined with one or more of the other indicia of significance described above. For example, if it was determined that the user preferred to receive weather information in the exemplary tile 361, then significant weather information, such as the presence of a tornado warning in the geographic area in which the user is located, can still be presented in the exemplary tile 361, except that the exemplary tile 361 could be shown in a visually greater size to convey the added significance of the information being presented therein.

The tiles 350, illustrated in the exemplary user interface 301 of FIG. 3a, are one mechanism by which a user can be proactively provided with information deemed relevant to such a user. In another embodiment, as illustrated by the exemplary user interface 302 of FIG. 3b, a notification icon 380 can be presented in the content presentation area 330. For ease of reference and description, the same elements of the exemplary user interfaces 301 and 302 are assigned the same numerical identifiers in both FIGS. 3a and 3b. The notification icon 380 can be a static icon, or it can dynamically alter its appearance depending upon the information to be proactively presented to the user. For example, if information deemed to be urgent is available for presentation to the user, the notification icon 380 can blink, change colors, or otherwise dynamically alter its appearance to alert the user to such urgent information. As another example, the color, size, and shape of the notification icon 380 can convey to the user the nature of the information being proactively presented to them.

In such an exemplary user interface, user interaction with the notification icon 380 can result in the presentation of the user interface element such as the drop-down display area 381 within which notifications, such as the exemplary notification 391, 394 and 396 can be presented to the user. While the exemplary user interface 302 of FIG. 3b illustrates only the three exemplary notifications 391, 394 and 396, additional notifications can be presented, including by accessing such notifications through known mechanisms, such as the scrollbar 382. In one embodiment, and initially presented set of notifications, such as the exemplary notifications 391, 394 and 396 can comprise a first set of most highly ranked information to be proactively presented to the user, while other notifications that could be accessed through further user action, such as via the scrollbar 382, can comprise sets of less highly ranked information.

As in the case of the tiles 350, shown in FIG. 3a, and described in detail above, the notifications 391, 394 and 396 can comprise images, such as the images 393, 396 and 399, respectively, notification text, such as the notification text 392, 395 and 397, respectively, or combinations of text and images. Additionally, user interaction with a specific notification can result in further information associated with such a notification being provided to the user.

As also described above, specifically within the context of the tiles 350, shown in FIG. 3a, the ordering or placement of the notifications within the drop-down display area 381 can be in accordance with a ranking or significance assigned to the proactively presented information associated with such modifications. For example, the information proactively presented via the notification 391 can have been assigned a higher ranking when the information privately presented via a notification 396. As another example, the same type of information can be repeatedly presented within the same relative area. Thus, sports information, for example, can be continuously presented via the notification 396 even if the linking of such sports information may have been higher.

With reference to both the exemplary user interface 301 of FIG. 3a and the exemplary user interface 302 FIG. 3b, in one embodiment, a lack of user interaction with tiles can comprise implicit user data, and can be utilized to further refine the user profile. For example, if a user avoids interacting with a tile or notification that provides proactively obtained information, such as, for example, flight tracking information, then an inference can be made, such as in the manner described in detail above, that the user no longer desires such flight tracking information and the user's profile can be updated accordingly. In such an instance, on subsequent presentations of the search engine homepage, such as that shown in the content presentation area 330, the flight tracking information will no longer be shown in the tiles or notifications. The tiles 350 of FIG. 3a, or the notifications shown in FIG. 3b, can, in one embodiment, be updated with each refresh or reloading of the search engine homepage, based upon the user profile and proactively obtained information existing at that time. Alternatively, they can be updated on a periodic basis or after a defined period of time has elapsed since a prior presentation of the search engine homepage to the user.

In addition to implicit user indications, the user profile can also be modified by explicit user indications, which can be provided through various user interface mechanisms. For example, in one embodiment, a user can provide explicit user indications through the tiles 350 themselves. For example, although not specifically illustrated, each tile or notification, can comprise a user interface element, in addition to the tile image and the tile text, which can enable the user to explicitly indicate that the user desires to continue to receive proactively presented information of the type shown in that tile, or, alternatively, which can enable the user to explicitly indicate that the user does not desire to continue to receive proactively presented information of the type shown in that tile.

In another embodiment, the user can be provided with a user interface that can enable the user to explicitly set aspects of the user profile. For example, a user interface can be presented through which a user can define which sports teams the user is interested in, which locations' weather forecasts the user wishes to receive, which flights the user is interested in tracking, and other like information. Such a user interface can enable the user to explicitly indicate the types of information that the user would desire to have proactively presented to them, such as through tiles or other like user interface elements. In one embodiment, the various options, or settings, which the user is enabled to select from can be informed by databases collected as part of the indexing of information performed by the search engine. For example, the search engine can, through indexing or other processing of obtained data, recognize each of the thirty-two National Football League teams as individual teams that can be presented to the user to enable the user to select one or more of them as a team in which the user has an interest. In such an embodiment, should one of those teams move to a different city, for example, or change names, such a change can be automatically detected as part of the indexing and entity processing performed by the search engine, and the user interface, through which a user can provide explicit user profile settings, can be automatically updated accordingly. In one embodiment, such a user interface, through which the user can explicitly provide user profile settings, can be accessed from the search engine homepage, such as through a settings icon 340 or other like user interface element.

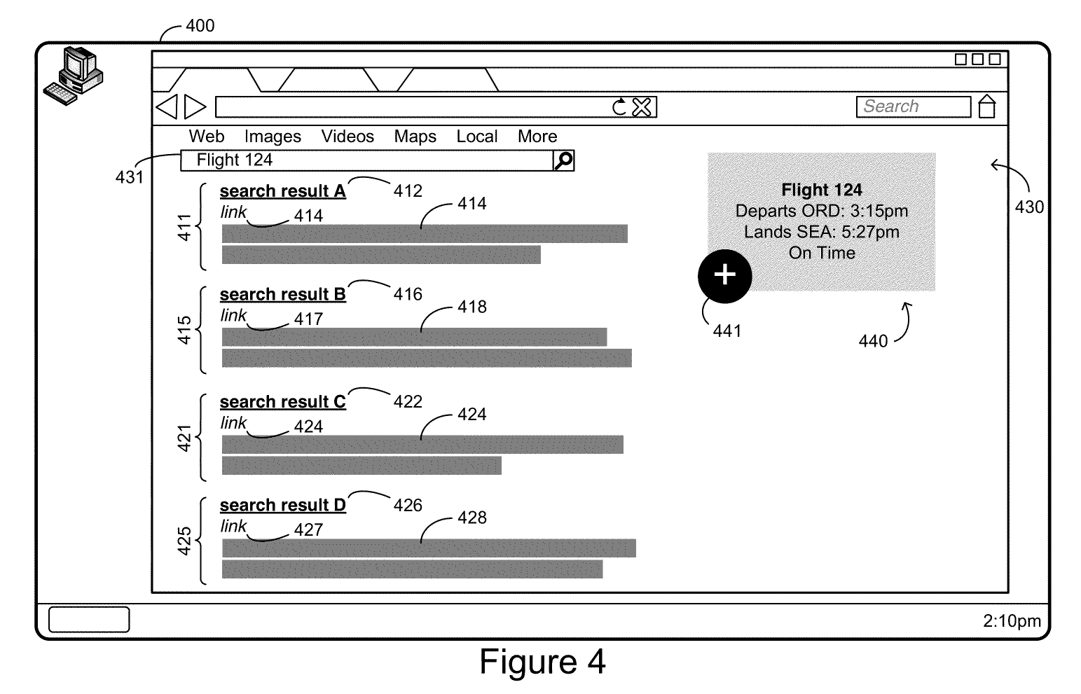

As indicated previously, in one embodiment, a user can identify specific information, or specific types of information, that the user desires to have proactively presented to them, as part of the search results provided to a user in response to a search. Turning to FIG. 4, the exemplary user interface 400 shown therein illustrates an exemplary presentation of search results, such as the exemplary search results 411, 415, 421 and 425, that can be provided in response to a search, such as that illustrated in the search entry area 431. The search results 411, 415, 421 and 425 can be presented in any format, though they are illustrated in the exemplary user interface 400 utilizing a common format for providing webpage search results within the context of the ubiquitous World Wide Web. Thus, for example, the search result 411 is shown as comprising an identification 412 of that search result, such as a name or title of the page or document identified, a link 413 to the page or document, and a snippet 414 comprising a small portion of the page or document, typically relevant to the user's search, that can be utilized to provide context for the user and to enable the user to quickly determine whether or not the search result 411 is what the user was searching for. In a similar manner, the search result 415 is shown as comprising an identification 416, a link 417 and a snippet 418, the search result 421 is shown as comprising an identification 422, a link 423 and a snippet 424, and the search result 425 is shown as comprising an identification 426, a link 427 and a snippet 428.

Depending upon the information searched for, the search engine may be able to identify a specific set of information, as opposed to a specific page or document, like those identified via the search results 411, 415, 421 and 425, that can specifically answer the query that the user appears to be making. For example, in the exemplary user interface 400 shown in FIG. 4, the user has performed a search for a specific airline flight number. While the search results 411, 415, 421 and 425 may link to pages or documents containing the same words as the user's query, they may not be able to immediately answer the question that the user is likely seeking to resolve given such a search, which is the status of the flight for which the user searched. Instead, in such instances, the search engine can separately present, such as in the area 440, information that the search engine is aware of that appears to directly answer the user's query. In the present example, the search engine can present, in the area 440, flight information regarding the flight the user has searched for including, for example, the departure and arrival times for the flight, the departure and arrival airports for the flight, in the on-time status of the flight.

In one embodiment, when a search engine is aware of such specific information, including by reference to specific databases or understandings of entities, the search engine can also provide to the user an ability to explicitly indicate that the user desires such specific information, or that type of information generally, to be proactively presented to the user. For example, a user interface element, such as the exemplary user interface element 441, can enable the user to explicitly indicate that the user desires to have the associated information, such as the status of the flight for which the user searched, proactively provided to them. Similar user interface elements can be provided to enable a user to explicitly indicate that they no longer desire to have such information proactively presented to them.

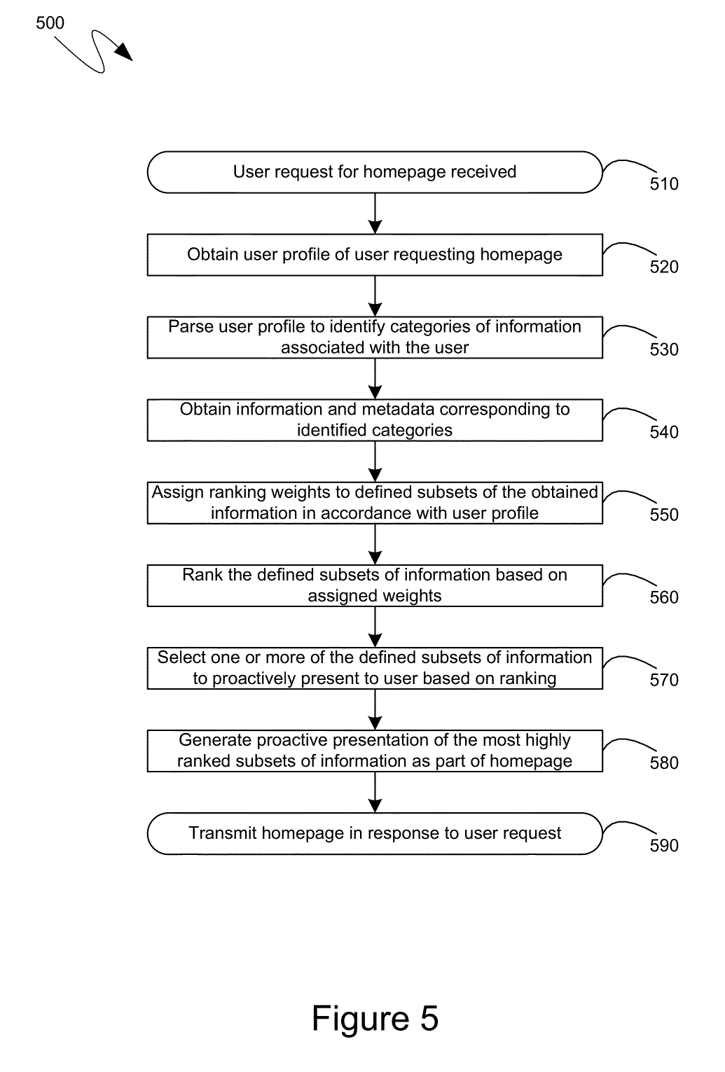

Turning to FIG. 5, the flow diagram 500 shown therein illustrates an exemplary series of steps by which virtual personal agent functionality can be provided to a user thru a homepage of a search engine or other like portal through which the user accesses information. Initially, as illustrated by step 510, a user request for the homepage of the search service can be received. The specific user, whose homepage request is received at step 510, can be identified through known user identification mechanisms including, for example, a user who is already logged in to a related web property and whose identity is transmitted as part of the user request for the homepage received at step 510, a user whose computing device comprises a “cookie” or other like collection of information that can be transmitted, along with the user request, at step 510, thereby enabling unique identification of the user, or other like user identification mechanisms. Subsequently, at step 520, the user profile corresponding to the user, whose request is received at step 510, can be obtained and can be parsed, at step 530, to identify categories of information that the user is believed to be interested in and which corresponding information should be proactively obtained for the user.

At step 540, current information and metadata, such as whether the information is generally perceived by others to be more or less important, whether the information is extraordinary or unusual, or any of the other like metadata described in detail above, can be obtained at step 540. Subsequently, at step 550, a weighting factor can be assigned to subsets of the information that was obtained at step 540. As utilized herein, the term “subset of information” means information that is presented and consumed as a singular whole. By way of example and not limitation, “subsets of information” include traffic information for a specific region, stock price data for a specific stock, a specific news article, flight information for a specific flight, weather data for a specific region, and the like. As indicated previously, such a weighting factor can be based, at least in part, on the metadata that was retrieved, at step 540. For example, if a stock price has deviated by a large percentage from its prior value, such a stock price can be assigned a higher weighting than the same stock price would be assigned if its deviation was more typical. As another example, if the departure time of a flight is proximate in time to the current time, than flight status information of such a flight can be assigned a higher weighting than information that is less time sensitive. The weighting factors assigned, at step 550, can also be influenced by indicators in the user profile such as, for example, if the user has indicated, either implicitly or explicitly, that the user desires one type of information more than another, different type of information. Once the weights are assigned at step 550, the ranking can be performed at step 560 in accordance with the weights that were assigned.

The ranking, performed at step 560, can inform the selection, at step 570, of one or more of the subsets of the obtained information, that is to be proactively presented to the user, such as part of the requested homepage. For example, in an embodiment, such as that illustrated in FIG. 3a, where five subsets of information could be presented in five tiles, the selection, at step 570, can select the top five subsets of the obtained information, as ranked at step 560. As another example, if an embodiment provided for multiple sets of tiles, a top five subsets of the obtained information, as ranked at step 560, could be selected, at step 570, to be proactively presented as an initial set of tiles, and a second five subsets of the obtained information, as ranked at step 560, could be further selected, at step 570, to be presented as a subsequent set of tiles, whose presentation can be explicitly invoked by the user, such as in the manner described in detail above. A homepage can then be generated, comprising the proactive presentation of the information that was selected at step 570, at step 580. The relevant processing can then end, at step 590, with the transmission of the homepage, generated at step 570, in response to the user request that was received at step 510.

In one embodiment, the transmission, at step 590, of the homepage can occur in a staged manner such that those portions of the homepage that are invariant and do not comprise the proactive presentation of information, such as the search entry area and the background image illustrated in exemplary user interfaces described above and shown in FIGS. 3a and 3b, can be transmitted after step 510 and do not need to wait for completion of steps 520 through 580. The remaining portions of the homepage, such as those that do comprise the proactive presentation of information can then be all that is transmitted as part of step 590, since the remaining portions of the homepage can have already been presented to the user. In such a manner, the homepage can appear to the user to be presented more quickly.

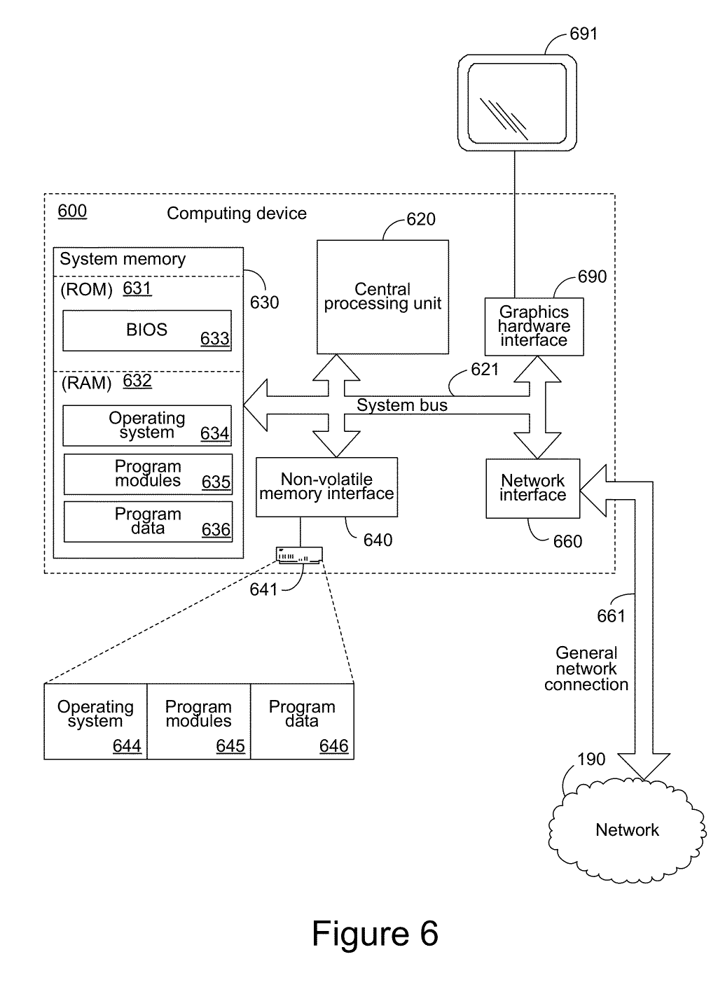

Turning to FIG. 6, an exemplary computing device 600 is illustrated. The exemplary computing device 600 can be any one or more of the computing devices illustrated in FIG. 1, whose operations were described in detail above. The exemplary computing device 600 of FIG. 6 can include, but is not limited to, one or more central processing units (CPUs) 620, a system memory 630, that can include RAM 632, and a system bus 621 that couples various system components including the system memory to the processing unit 620. The system bus 621 may be any of several types of bus structures including a memory bus or memory controller, a peripheral bus, and a local bus using any of a variety of bus architectures. The computing device 600 can optionally include graphics hardware, such as for the display of visual user interfaces, including, but not limited to, a graphics hardware interface 690 and a display device 691, which can include display devices capable of receiving touch-based user input, such as a touch-sensitive, or multi-touch capable, display device. Depending on the specific physical implementation, one or more of the CPUs 620, the system memory 630 and other components of the computing device 600 can be physically co-located, such as on a single chip. In such a case, some or all of the system bus 621 can be nothing more than silicon pathways within a single chip structure and its illustration in FIG. 6 can be nothing more than notational convenience for the purpose of illustration.

The computing device 600 also typically includes computer readable media, which can include any available media that can be accessed by computing device 600 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 600. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and the aforementioned RAM 632. A basic input/output system 633 (BIOS), containing the basic routines that help to transfer information between elements within computing device 600, such as during start-up, is typically stored in ROM 631. RAM 632 typically contains data and/or program modules that are immediately accessible to and/or presently being operated on by processing unit 620. By way of example, and not limitation, FIG. 6 illustrates the operating system 634 along with other program modules 635, and program data 636.

The computing device 600 may also include other removable/non-removable, volatile/nonvolatile computer storage media. By way of example only, FIG. 6 illustrates the hard disk drive 641 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640.

The drives and their associated computer storage media discussed above and illustrated in FIG. 6, provide storage of computer readable instructions, data structures, program modules and other data for the computing device 600. In FIG. 6, for example, hard disk drive 641 is illustrated as storing operating system 644, other program modules 645, and program data 646. Note that these components can either be the same as or different from operating system 634, other program modules 635 and program data 636. Operating system 644, other program modules 645 and program data 646 are given different numbers hereto illustrate that, at a minimum, they are different copies.

The computing device 600 can operate in a networked environment using logical connections to one or more remote computers. The computing device 600 is illustrated as being connected to the general network connection 661 through a network interface or adapter 660, which is, in turn, connected to the system bus 621. In a networked environment, program modules depicted relative to the computing device 600, or portions or peripherals thereof, may be stored in the memory of one or more other computing devices that are communicatively coupled to the computing device 600 through the general network connection 661. It will be appreciated that the network connections shown are exemplary and other means of establishing a communications link between computing devices may be used.

As can be seen from the above descriptions, mechanisms and user interfaces for proactively presenting information through a search interface have been enumerated. In view of the many possible variations of the subject matter described herein, we claim as our invention all such embodiments as may come within the scope of the following claims and equivalents thereto.

We claim:

1. A method for proactively providing information to a user, the method comprising the steps of:
receiving, from the user, a request for a document representing a portal through which the user accesses information;
obtaining, from a user profile associated with the user, identifications of information to collect and proactively present to the user, the information to collect being identified based on explicit user indications and inferences from implicit user indicators;
collecting the identified information and associated metadata;
ranking the collected information to identify defined subsets of information most likely to be desired by the user at the time the defined subsets are proactively presented to the user; and
generating the requested document to comprise two or more defined subsets of information that are most highly ranked by the ranking.

2. The method of claim 1, wherein the requested document is a homepage of a search engine.

3. The method of claim 1, wherein the generating the requested document comprises generating graphical tiles, each graphical tile comprising text and an image that are associated with a one of the two or more defined subsets of information.

4. The method of claim 1, wherein the ranking the collected information is performed in a time-based manner, such that defined subsets of information associated with events occurring more proximate to a current time are ranked more highly.

5. The method of claim 1, wherein the ranking the collected information is performed in a confidence-based manner, such that defined subsets of information associated with aspects of the user profile having high confidence are ranked more highly.

6. The method of claim 1, wherein the implicit user indicators comprise prior searches by the user.

7. The method of claim 1, wherein the explicit user indicators are associated with answers to a prior searches that the user explicitly indicated were of interest.

8. The method of claim 1, wherein the explicit user indicators are associated with information explicitly requested by the user through applications differing from an application through which the user made the request for the document.

9. A graphical user interface, physically generated on a physical display device by a computing device, proactively providing information to a user, the user interface comprising:
a user query entry area through which the user can enter queries to search for information; and
at least two indicators of defined subsets of the proactively provided information, each indicator being associated with one of the defined subsets of the proactively provided information selected from among most highly ranked defined subsets of information that was obtained in accordance with a user profile, the ranking reflecting information deemed most likely to be desired by the user at the time the graphical user interface is presented to the user.

10. The graphical user interface of claim 9, wherein each indicator is a graphical tile comprising text and graphics representative of the specific proactively provided information associated with that indicator.

11. The graphical user interface of claim 10, wherein the at least two indicators comprise a row of the graphical tiles visually positioned across the graphical user interface, the graphical user interface further comprising user selection elements for selecting another row of graphical tiles representative of specific proactively provided information having a lower ranking.

12. The graphical user interface of claim 10, wherein the at least two indicators comprise a row of the graphical tiles visually positioned across the graphical user interface, and wherein further different proactively provided information sharing a common type are provided though tiles positioned in a same location of the row across multiple generations of the row.

13. The graphical user interface of 9, further comprising a user interface element, associated with a first of the at least two indicators, by which the user indicates their desire to continue to be proactively presented with a subset of the provided information that is associated with the first of the at least two indicators.

14. The graphical user interface of 9, further comprising a notification icon, wherein the at least two indicators are only presented to a user via the graphical user interface in response to user action directed to the notification icon.

15. The graphical user interface of claim 9, further comprising a user setting icon through which a user accesses user settings and thereby provides explicit user indications for the user profile.

16. One or more computer-readable media comprising computer-executable instructions for proactively providing information to a user, the computer-executable instructions directed to steps comprising:
obtaining, from a user profile associated with the user, identifications of information to collect and proactively present to the user, the information to collect being identified based on explicit user indications and inferences from implicit user indicators;
collecting the identified information and associated metadata;
ranking the collected information to identify defined subsets of information most likely to be desired by the user at the time the defined subsets are proactively presented to the user; and
generating a search engine homepage comprising a user query entry area through which the user can enter queries to search for information and at least two indicators of specific ones of the defined subsets of the proactively provided information, selected from among a most highly ranked defined subsets of the proactively provided information, the ranking reflecting information deemed most likely to be desired by the user at the time of the generating the search engine homepage.

17. The computer-readable media of claim 16, wherein the computer-executable instructions for ranking the collected information comprise computer-executable instructions for ranking the collected information in a time-based manner, such that defined subsets of information associated with events occurring more proximate to a current time are ranked more highly.

18. The computer-readable media of claim 16, wherein the computer-executable instructions for ranking the collected information comprise computer-executable instructions for ranking the collected information in a confidence-based manner, such that defined subsets of information associated with aspects of the user profile having high confidence are ranked more highly.

19. The computer-readable media of claim 16, wherein the implicit user indicators comprise prior searches performed by the search engine for the user.

20. The computer-readable media of claim 16, wherein the explicit user indicators are associated with answers to a prior searches, performed by the search engine for the user, that the user explicitly indicated were of interest.
